(19) United States
(12) Patent Application Publication
(10) Pub. No.: US 2024/0125307 A1
(43) Pub. Date: Apr. 18, 2024

(54) Directional Motive Force Generation Device

(71) Applicant: Richard Lauch, RARITAN, NJ (US)

(72) Inventor: Richard Lauch, RARITAN, NJ (US)

(21) Appl. No.: 18/531,133

(22) Filed: Dec. 6, 2023

Related U.S. Application Data
(63) Continuation-in-part of application No. 16/445,504, filed on Jun. 19, 2019, now abandoned.
Application No. 16/445,504 is a continuation of application No. 15/347,123, filed on Nov. 9, 2016, now abandoned.
Application No. 15/347,123 is a continuation of application No. 14/290,456, filed on May 29, 2014, now abandoned.

(51) Int. Cl. F03G 7/10

(52) U.S. Cl. CPC F03G 7/125; Y10T 74/18528

(57) ABSTRACT

A motive force generation device for generating a net resultant propulsive force vector. The device includes a mechanical drive that rotates one or more counter-rotating mass pairs about a respective axis; decreases the radius about the axis without causing external torque on the system therefore increasing the energy level of the mass; continues to rotate mass at the higher energy level; then increases the radius about the axis to its original distance. The work required to rotate mass at a higher energy state is greater than the work to rotate mass at the original state, causing an unbalanced system resulting in the net propulsive force. This force is transferred to an object to which the device is attached, effecting movement.

### CROSS-REFERENCE TO RELATED APPLICATIONS

This application is a continuation-in-part of U.S. patent application Ser. No. 16/445,504, filed 2019 Jun. 19 (pending), which is a continuation of U.S. patent application Ser. No. 15/347,123, filed 2016 Nov. 9 (abandoned), which is a continuation of U.S. patent application Ser. No. 14/290,456, filed 2014 May 29 (abandoned).

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### STATEMENT REGARDING PRIOR DISCLOSURES BY THE INVENTOR OR A JOINT INVENTOR

Not Applicable

### TECHNICAL FIELD

The present invention relates to mechanical propulsion devices.

### BACKGROUND OF THE INVENTION

Typical propulsion devices utilize electrical, mechanical, chemical, or some combination of electrical, mechanical, and/or chemical to generate a motive force to propel an object. One example is a typical motor vehicle, which relies on a combustion engine to propel the vehicle. Such vehicles rely on a chemical reaction (combustion) to impart force on the pistons inside the engine to create a linear motion, which is translated to rotational motion of the vehicle's tires through a crankshaft and gearing arrangement. This rotational motion of the tires is translated to linear motion of the vehicle due to action of friction between the tires and the surface with which they are in contact.

Another example is a chemical rocket, which relies on the expulsion of high-velocity gas to create sufficient force to push the rocket along a desired path in a direction opposite that of the expelled gas. Modern airplanes and jets rely on this same expulsion of gas principle. Jet engines combust fuel to expel a high-velocity gas rearward, thereby propelling the jet forward due to the rearward force of the expelled gas. Propeller-driven airplanes rely on a combustion engine or gas turbine to rotate the propeller, the angled blades of which impart a force on the air aft of the propeller, which generates a propulsive force in the opposite direction on the blade and, consequently, on the airplane to produce forward motion.

Regardless of the type of propulsion device, each operates under the principles of Newtonian Laws of Physics, which include the Laws of Motion, Properties of Inertia, Conservation of Energy and Conservation of Momentum, appearing as:
Inertia=mass*radius\hat{ }2 (simplified as a point mass).
Conservation of angular momentum: L=Inertia*angular velocity (where L is a constant provided there is no external torque on the system)
Rotational energy=Inertia*angular velocity\hat{ }2
Linear Kinetic Energy=½*mass*velocity\hat{ }2.
   At the core is the basic law of Newtonian physics that for every action there is an equal and opposite reaction.

A tremendous disadvantage to such traditional propulsion devices is the requirement for friction and for large volumes of fuel for thermal chemical reactions. This introduces limitations in the sense that friction surfaces wear over time, causing the friction coefficient to vary unpredictably. Moreover, and the volume of fuel that is required is often so large that the payloads that may be supported is severely reduced. What is needed is a drive system that generates a motive force that overcomes such limitations.

### BRIEF SUMMARY OF THE INVENTION

A directional motive force generation device is provided as set out in the appended claims.

### BRIEF DESCRIPTION OF THE SEVERAL VIEWS OF THE DRAWING(S)

The present invention may be more fully understood by reference to the following detailed description of the preferred embodiments of the invention when read in conjunction with the accompanying drawings, wherein:

FIG. 1 presents a diagram depicting the effects of the energy state of a mass as its radius changes as it rotates about a center point;

FIG. 2 presents a diagram depicting the kinetic energy relative to the work done on the mass as it rotates about the center point;

FIG. 3 presents a diagram depicting the use of a secondary driven system that is synchronized with a primary driver system;

FIG. 4 presents a first embodiment of a motive force generation device as described herein;

FIG. 5 presents an exploded view of the primary drive mass and secondary driven mass of the embodiment, highlighting their respective, synchronized orientations;

FIG. 6 presents an exploded view of the framework structure surrounding the primary drive mass and secondary driven mass of the embodiment;

FIG. 7 presents a partly assembled, partly exploded view of the embodiment highlighting attachment of the energetic drive means and optional braking means;

FIG. 8 presents an exploded view of the secondary driven mass and shaft assembly of the embodiment;

FIG. 9 presents the attachment of a power buss for energizing the actuator devices of the embodiment;

FIG. 10 presents the actuator trigger mechanism of the embodiment;

FIG. 11 presents an alternate embodiment in which multiple driver/driven mass pairs are utilized;

FIG. 12 presents a close-up view of the trigger mechanism in relation to the actuator sensors in a first position;

FIG. 13 presents a close-up view of the trigger mechanism in relation to the actuator sensors in a second position;

FIG. 14 present a close-up view of the trigger mechanism in relation to the actuator sensors in a third position;

FIG. 15 presents a first stage of the embodiment operation;

FIG. 16 presents a second stage of the embodiment operation;

FIG. 17 presents a third stage of the embodiment operation;

FIG. 18 presents a fourth stage of the embodiment operation;

FIG. 19 presents an alternate mass for utilization with another embodiment of a motive force generation device;

FIG. 20 presents the alternate mass carrier assembly; and

FIG. 21 presents the alternate mass and carrier assembly within the assembly actuator U-shaped mounting bracket.

The above figures are provided for illustration and description only, and are not intended to limit the disclosed invention. Use of the same reference number in multiple figures is intended to designate the same or similar parts. Furthermore, if, and when, the terms “top,” “bottom,” “first,” “second,” “upper,” “lower,” “height,” “width,” “length,” “end,” “side,” “horizontal,” “vertical,” and similar terms are used herein, these terms are intended to reference only the structure shown in the drawing to facilitate describing the specific embodiment. The extension of the figures with respect to number, position, relationship, and dimensions of the parts to form the preferred embodiment will be explained or will be within the skill of the art after the following teachings of the present invention have been thoughtfully considered.

### DETAILED DESCRIPTION OF THE INVENTION

The novel drive system device described herein presents a mechanical rotational system that does more work to one side of the rotational system than the other. This difference in work allows the device, attached to an object, to apply a force to the object resulting in its motion without use of chemical propellants.

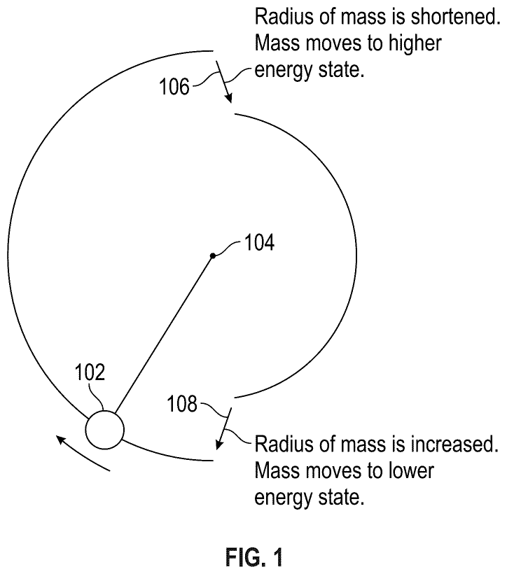

FIG. 1 presents, for background, a diagram depicting the effects of the energy state of a mass as its radius changes as it rotates about a center point. The mass (102) is rotated at angular velocity ω at distance “r” from the axis (104). As the rotating mass is drawn closer to the axis of rotation without applying an external torque (106), its inertia is reduced which causes its angular velocity to increase according to conservation of angular momentum L=I*ω. Conversely, as the rotating mass is allowed to return to its original radius (108) without applying an external torque, its inertia is increased which causes its angular velocity to decrease. Kinetic energy is determined by the formula Ke=½* Inertia*angular velocity \hat{ }2, which establishes that velocity is a square function while inertia is not. Therefore, the inverse linear function of the conservation of momentum formula dictates that the energy of the system increases as its inertia decreases provided that no external torque is applied.

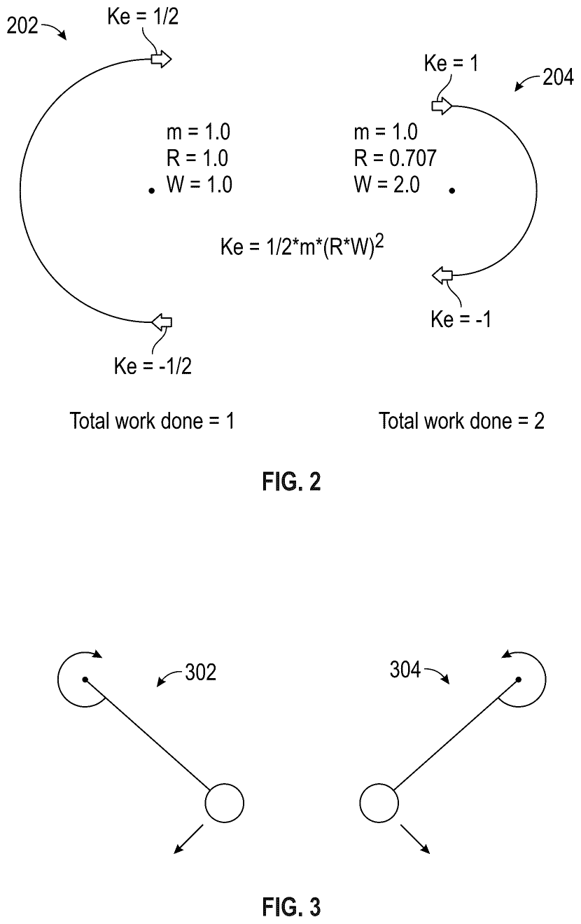

FIG. 2 presents, for background, a diagram depicting the kinetic energy relative to the work done on the mass as it rotates about the center point. In this example, mass (m) rotating clockwise at an angular velocity (ω) at distance (r) from the axis at the 6 o'clock position has an angular energy of ½*(m*r\hat{ }2)*(ω\hat{ }2). Assume mass=1, ω=1 and r=1, which gives it an instantaneous linear energy of ½*m*(ω*r)\hat{ }2 or ½ (units omitted). If the mass rotates 180 degrees to the 12 o'clock position the work done is twice the initial kinetic energy of the mass or 1, since the mass will travel at the same velocity in the opposite direction: ½−(−)½=1 (202).

Consider now that at the 12 o'clock position work is done to the mass to pull it in towards the axis to a radius of 0.707, which effectively cuts the Inertia in half. Given the formula I=m*r\hat{ }2, the square of 0.707 is 0.5. This results in an increase in angular velocity of 100% to 2 from the conservation of angular momentum formula: L=I*ω. Therefore, in this section of the rotation the mass=1, ω=2 and r=0.707, giving an instantaneous linear energy of ½*m*(ω*r)\hat{ }2 or 1 (units omitted). If the mass rotates 180 degrees to the 6 o'clock position the work done is twice the kinetic energy of the mass at 12 o'clock or 2, since the mass will travel at the same velocity in the opposite direction: −1(−)1=−2 (204). When the mass returns to the 6 o'clock position again the mass is moved back to radius r, then the energy level of the system is again returned to its original levels the cycle may repeat.

FIG. 3 presents a diagram depicting the use of a secondary driven system that is synchronized with a primary driver system. To eliminate the forces of acceleration throughout the rotation of the primary drive mass and isolate the intended directional force vector, the secondary driven system (304) is synchronized with the primary driver system (302) traveling in opposite rotational direction so that the unnecessary force components are cancelled out and the reactionary forces present to pull the masses towards and push them away from the axis of rotation are cancelled out.

As the masses rotate faster to achieve higher output, the triggers that activate the actuators maybe be rotated or advanced using a timing mechanism that incorporates a cam and follower much like a traditional automotive ignition system. This allows the masses to reach their desired energy levels before they enter the opposite semicircle of the rotation. Thus, the two rotational paired masses provide work in a specific direction overall (a resultant net force vector). However, while the resultant net force vector is useful work in a specific direction the pulse output might be undesirable depending on the application. Any undesirable pulse output may be effectively minimized through the utilization of additional paired masses (i.e., additional paired primary driver/secondary driven systems), each pair of which rotates out of phase with each other pair. The greater the number of paired masses, each rotating out of phase with the others, the more the pulse output is minimized.

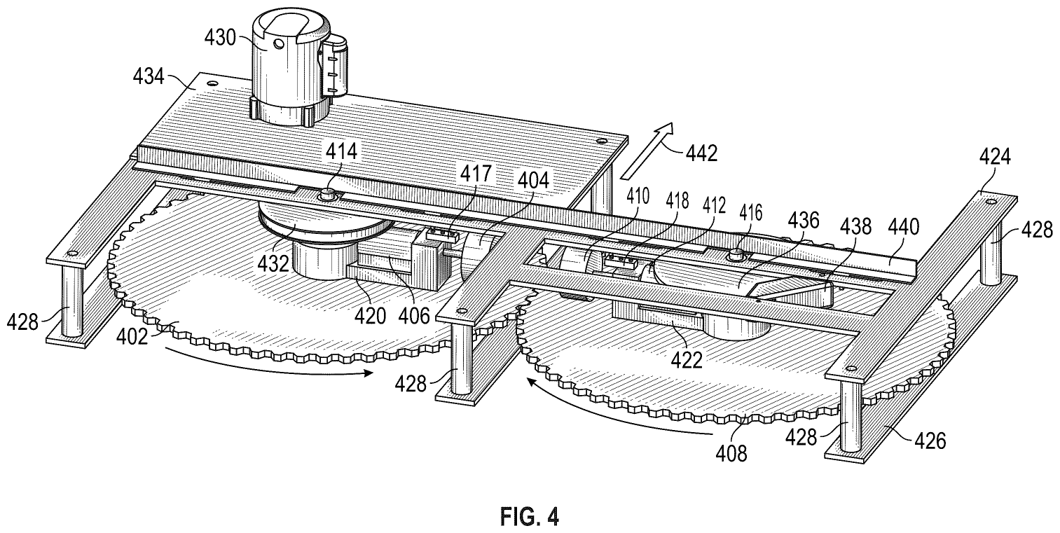

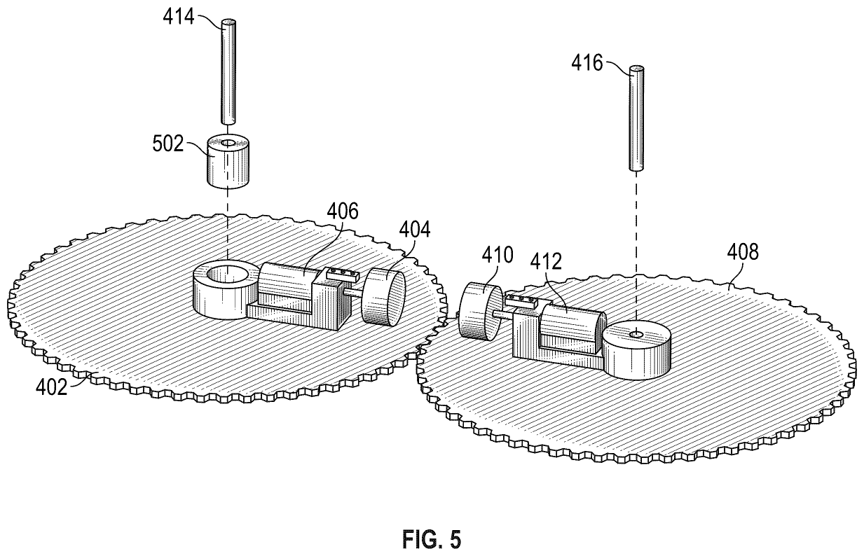

FIG. 4 presents an assembled view of a first embodiment of a motive force generation device as described herein. The various components are highlighted in exploded views of the embodiment found in FIGS. 5 to 10. The embodied device generally includes rotating masses (404 and 410) and an actuator means (406 and 412, respectively) associated with each mass, for varying the radius, or distance of the masses from the axis (414 and 416, respectively).

The present embodiment utilizes an electrical solenoid receiving its power inductively or through slip rings oriented about the axis, with timing pulses provided based on a trigger device (440) and the rotation of the gears (402 and 408). The actuators (406 and 412) move the masses (404 and 410, respectively) towards or away from the axis in a slidable manner that does not apply external torque to the system, thereby varying the radius of each mass (404 and 410) from the respective axis.

The actuators (406 and 412) may be located in-line with the travel path of the masses (404 and 410, respectively) or in other embodiments may be oriented remotely and out of line with the line of travel of the masses (404 and 410, respectively), each transmitting force through a mechanical or magnetic linkage means. A bracket (420 and 422) is also utilized to support and/or guide the masses (404 and 410, respectively) as they are driven about the axis and moved towards and away from the axis. One of ordinary skill in the art will understand and appreciate that other embodiments may utilize pneumatic, electric, magnetic, mechanical actuators, or some combination of the like, and may utilize programmable logic controllers or other programmable devices capable of generating and receiving trigger signals for rotation, and actuating the masses in relation to angular rotation. The implementation of such actuators is within the skill of one having ordinary skill in the art to which the invention pertains.

The motive force generation device embodiment also includes a synchronization means (402 and 408) to synchronize the primary drive mass and secondary driven masses (404 and 410, respectively). This synchronization means of the present embodiment is formed from the mechanical linkage of gears as depicted, but may be in any mechanical linkage form including gears, timing belts, or some combination of same that ensures the masses are rotating in opposite directions about the axis (414 and 416) and in line with one another. The secondary driven mass (410) is positioned at a negative of the angle of the primary driver mass (404) to an imaginary line tangential to the two paths of travel of both masses (404 and 410).

FIG. 5 presents an exploded view of the primary drive mass and secondary driven mass highlighting their respective, synchronized orientations and timing arrangement. Visible in this figure is the overrun device (502) that allows the masses (404 and 410) to run faster than the driven input shaft (414) when the energy level of each mass is raised by moving the mass closer to the axis (414 and 416). This overrun device includes, but is not limited to, over-running clutches, mechanical sprag clutches, one-direction bearings, or some combination of same, or other such means commonly known in the mechanical arts.

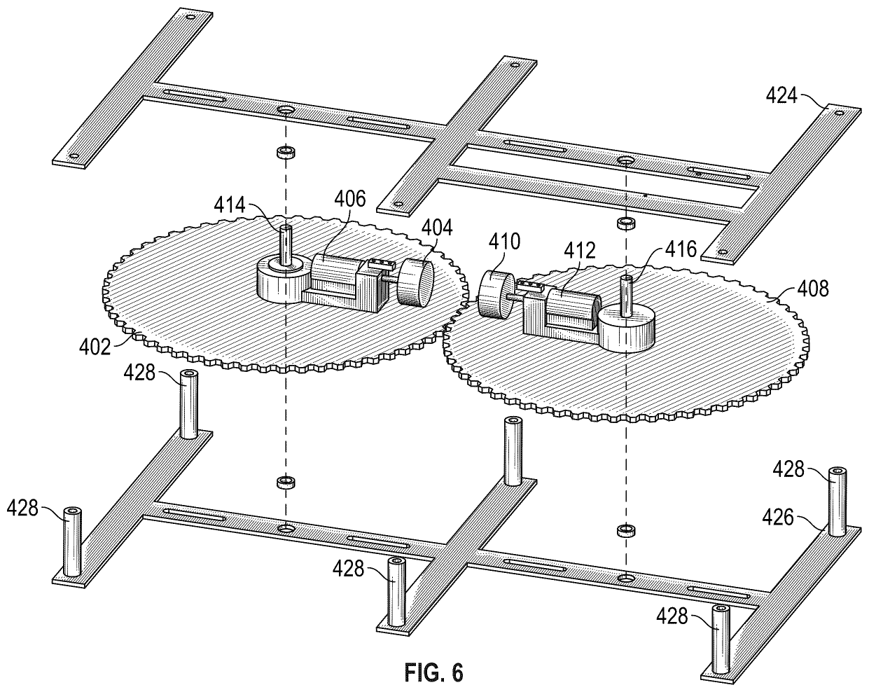

FIG. 6 presents an exploded view of the framework structure surrounding the primary drive mass and secondary driven mass. As depicted, the drive embodiment includes shafts (414 and 416) to support the rotating masses that are positioned within the framework (424 and 426) via sleeved bearings. Standoffs (428) maintain proper spacing of the framework to allow for rotation of the masses to occur without undue movement of the components relative to one another. Also, the assembled framework (424/426) provides a mounting point to allow the device to transfer its motive force to a larger object.

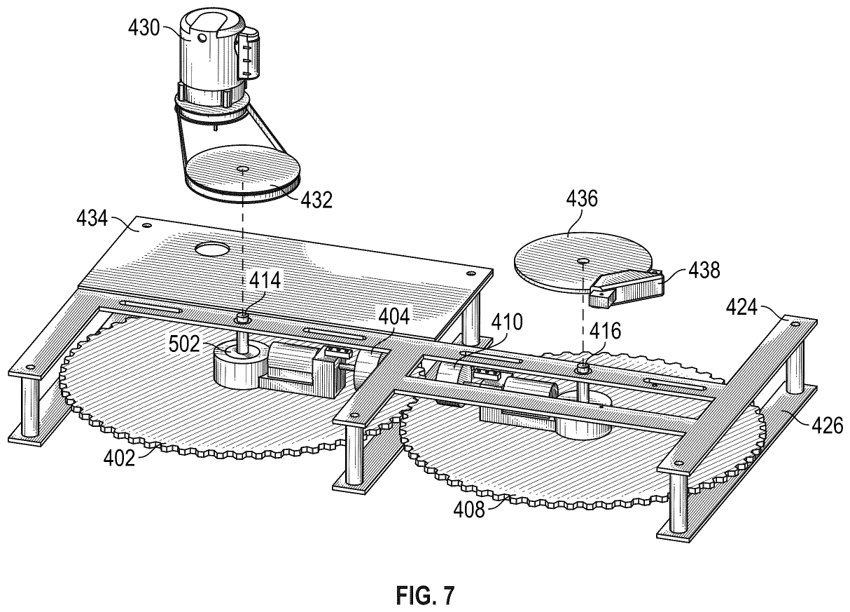

FIG. 7 presents a partly assembled, partly exploded view of the embodiment highlighting attachment of the energetic drive means (430, 432) and optional braking means (438, 436). The embodiment shown utilizes a conventional electric motor as the energetic drive means, but may utilize such other energetic drive means capable of producing axial rotation of a pulley (432) attached to the input shaft (414). One of ordinary skill in the art will understand and appreciate that alternatives may be used as a drive means to input energy into the system. For example but not limitation, a flexible coupling or direct- drive shaft may be used in place of the depicted pulley driven system. The energetic drive means is fixed positionally to the system through hard mounting (434) or other conventional attachment means. The driven shaft (414) attaches to the overrun device (502) to transfer input energy to the drive (402) and driven (408) gears, which transfers to the masses (404 and 410).

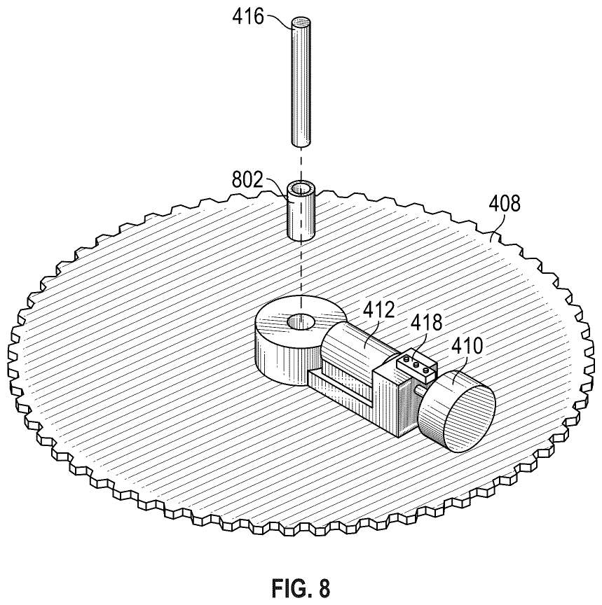

FIG. 8 presents an exploded view of the secondary driven mass and shaft assembly. As depicted, the axle shaft (416) may be fixed to the mass or allowed to free spin via a bearing (802) depending on the application. In applications that require a braking force the axle may be fixed to the mass to provide a mounting point for a brake rotor or similar braking apparatus. FIG. 7 presents such a braking apparatus as a brake rotor (436) and caliper having friction pads that contact the brake rotor. Actuation means for the brake caliper include hydraulic (for example—as in automotive applications), electric, or pneumatic.

Also envisioned are electromagnetic braking means, for example, that utilize the electromagnetic forces of a generator to slow the masses rotation. Such electromagnetic forces may also be utilized to produce electricity, for example, as in the well-known regenerative braking system in use on modern electric automobiles.

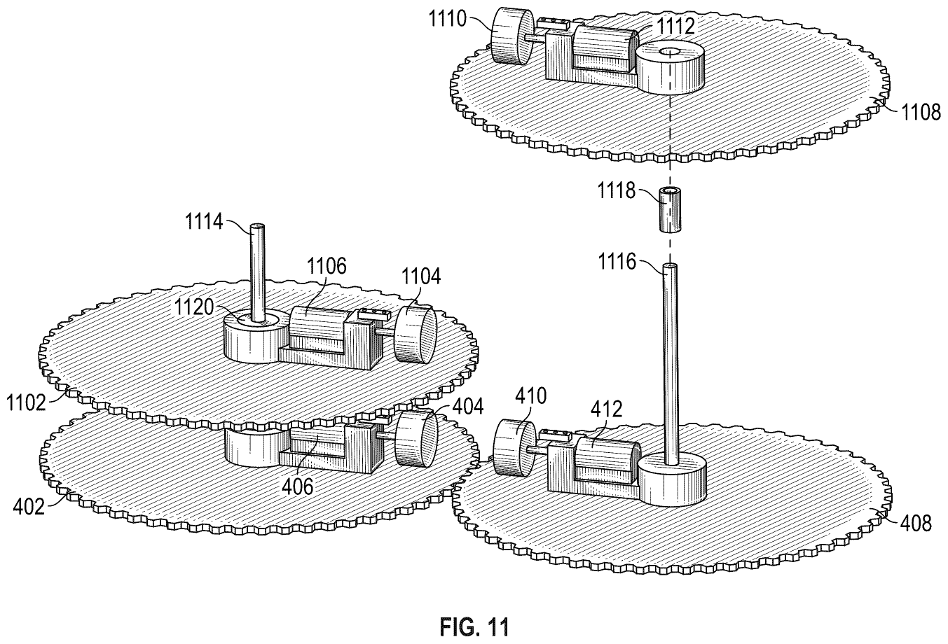

In applications that do not require a braking force the shaft may be mounted to the mass with a bearing (802) so that the driven mass may turn independently of the shaft. For example, several driven masses may be mounted to a single shaft with corresponding driving masses on the input shaft. FIG. 11 presents an alternate embodiment in which multiple drive/driven mass pairs are provided. As depicted in this figure, a matching drive gear (1102), actuator (1106), and mass (1104) is “stacked” upon an extended drive axle (1114), with power transmitted from the axle through a matching overrun device (1120). Likewise, a matching secondary driven gear (1108), actuator (1112), and mass (1110) are “stacked” upon an extended axle shaft (1116) with bearing (1118). Other embodiments may include additional pairs of drive/driven masses, the effect of which, as previously stated, reduces output pulsing that may occur.

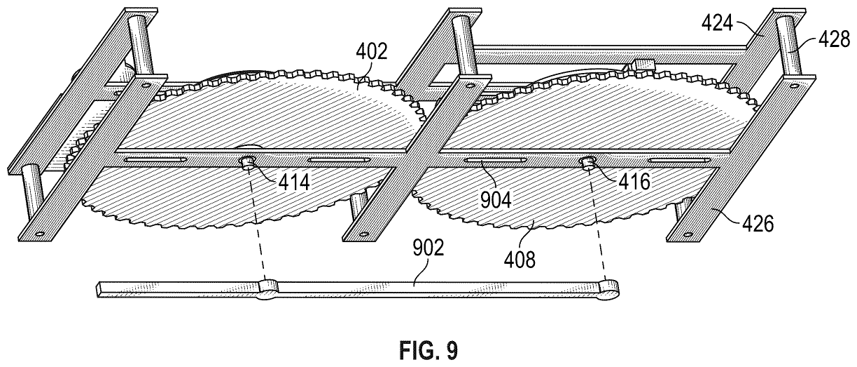

FIG. 9 presents the attachment of a power buss for energizing the actuator devices. As depicted, electrical wires or busses are provided (902) to provide energy via slip rings or conductors embedded in the axles (414 and 416). An external battery or other source of energy transfers electrical power to the actuators via this path. In other embodiments that utilize pneumatic or hydraulic controls, appropriate plumbing may be utilized with rotary couplings at the axle interfaces. Such energization means are well known and need not be discussed herein.

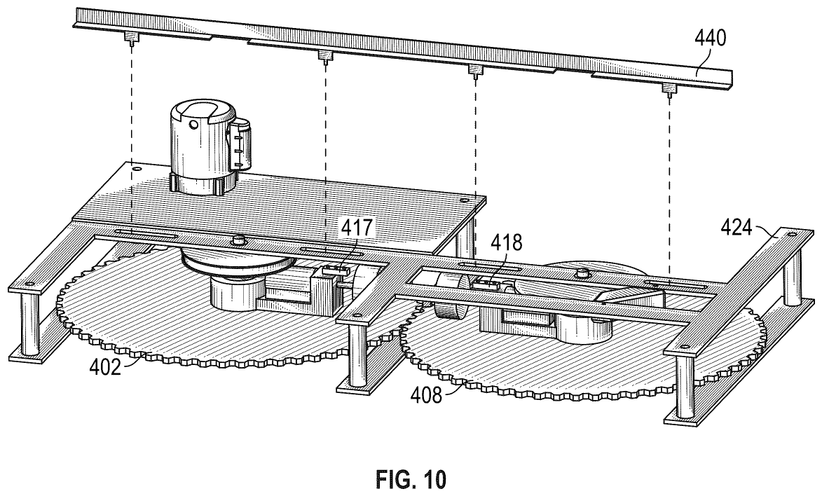

FIG. 10 presents the actuator trigger mechanism of the present embodiment. As depicted, the trigger mechanism (440) interacts with the actuator sensors in a timed fashion to cause the actuators to move the masses towards or away from the axis of rotation, thereby raising and lowering the energetic state of each respective mass. The triggers may be mounted either on the rotating masses, any of its supporting components or on the frame (424) as depicted.

In the present embodiment a selector linkage activates the trigger mechanism (440) to cause it to move to a desired position relative to the actuator sensors (417 and 418). The actuator sensor means may be mechanical, magnetic, photo, electrical or any other well-known and understood means. For example, in the present embodiment the device utilizes hall-effect sensors that detect the position of the trigger mechanism (440) with respect to the actuator sensor (417 and 418). In other embodiments the trigger mechanism (440) may be fixed in relation to the frame or may be movable to change behavior of the drive dependent on the device operational state.

The selector in its basic form interacts with the actuator sensors (417 and 418) to activate each actuator to pull the respective mass in towards the axis of rotation at a preset angle of rotation, and then returns each mass to the initial position at another present angle of rotation. The trigger mechanism (440) position may adjust or advance the timing of this signal mechanically or electronically based on the rotational speed of the masses by utilizing a positioning means to change the state based on user input.

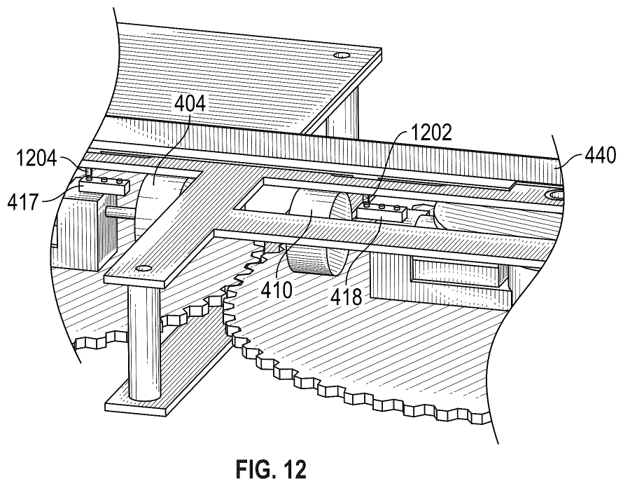

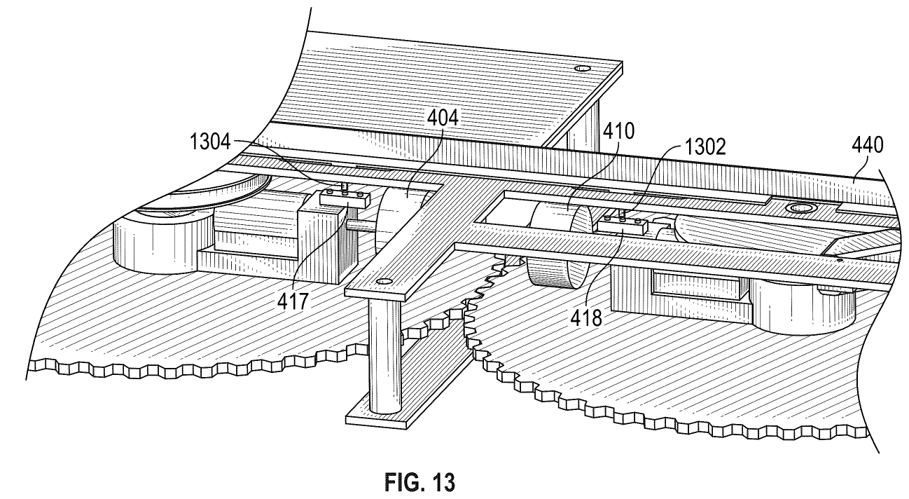

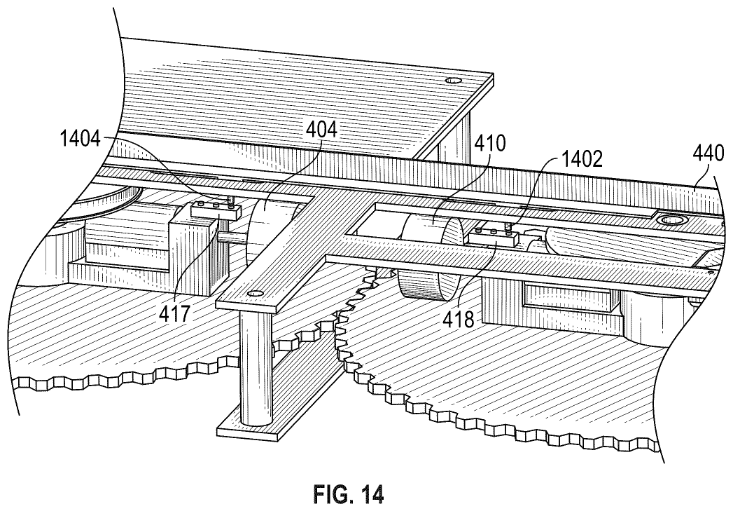

FIGS. 12, 13, and 14 present a close-up view of the trigger mechanism in relation to the actuator sensors, with a different position depicted in each. For example, in FIG. 12 the trigger mechanism (440) is positioned to the left. The mass (404) on the left has its actuator sensor (417) inside trigger activated in this position (1204) but has its outside trigger activated when it is 180 degrees from this position. This can be used to provide net resultant trust in a particular direction. In FIG. 13 the trigger mechanism (440) activates the actuator sensor (417) center trigger (1304) on both this position and at 180 degrees from this position. This is a neutral drive providing net resultant trust in neither direction. Likewise, in FIG. 14 the trigger mechanism (440) activates the actuator sensor (417) outside trigger (1404) in this position and the inside trigger at 180 degrees to this position, providing a net resultant thrust in a direction opposite that of FIG. 12. This may be useful as a braking trust or reverse mode if the application requires it.

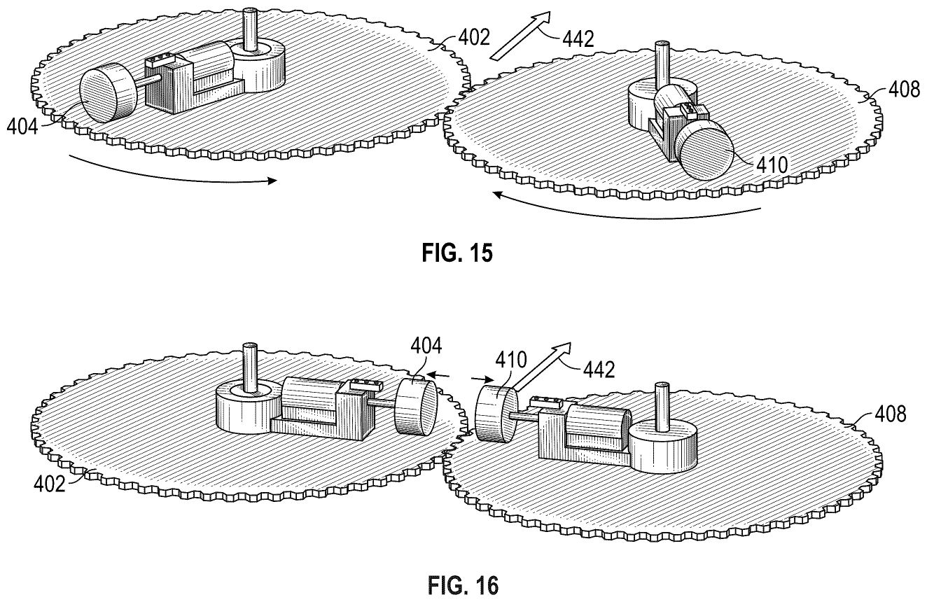

FIGS. 15, 16, 17, and 18 present different stages of the drive operation. In the first operational stage of FIG. 15, each synchronized mass (404 and 410) is at its furthest point from the axis and is driven rotationally by the energetic drive means input, which adds energy to the system and which overcomes the frictional forces on the system or adds energy to the mass as required by the application or physical demands on the system. In this stage the overrun device is engaged with the shaft and transmitting power to the driver mass (404). The driven mass (410) is being driven by the driver mass system such that its velocity is equal in the opposite direction of rotation. During this stage the velocity of the mass is changed 180 to its initial velocity. In other words, work is done to the mass.

In the second operational stage of FIG. 16, each actuator is triggered and the attached masses (404 and 410) are moved inward towards the axis of rotation, thereby decreasing their moment of inertia and increasing their angular velocity and energy state.

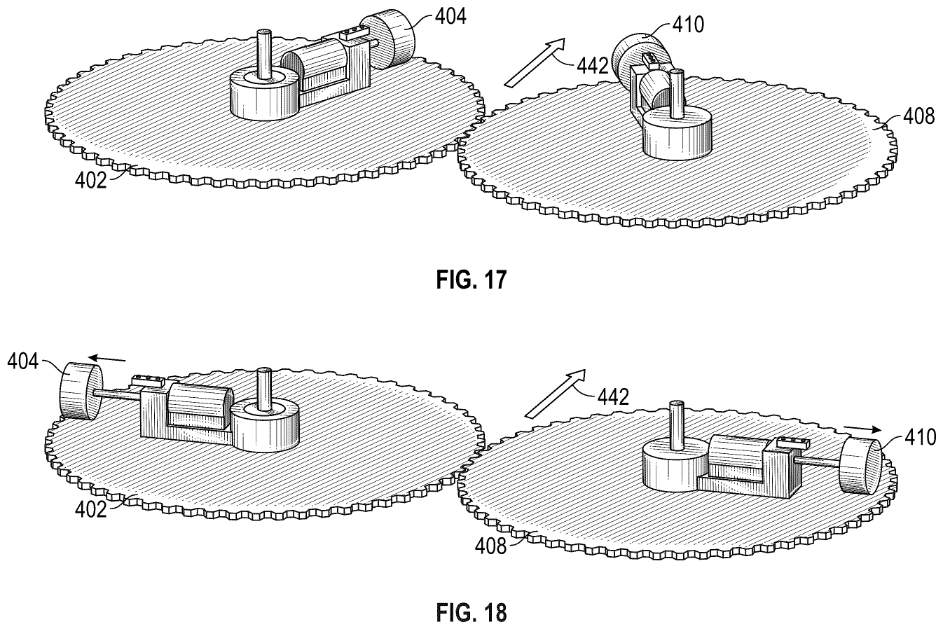

In the third operational stage of FIG. 17, the masses (404 and 410) in the elevated state of energy rotate faster about the axis than in the first stage (FIG. 15). The presence of the overrun device allows the mass to rotate faster due to the action of the overrun device, lest the energetic drive means introduce resistance to rotation. During this third stage the velocity of the mass is reversed and the mass exits the stage at a negative velocity of that which it enters, minus any losses for friction.

In the fourth operational stage of FIG. 18, the actuators are triggered and each mass is moved outward, lengthening the radius and returning each to its lower energetic level, or its furthest position from the axis of rotation (decreasing increasing their moment of inertia and decreasing their velocity). The masses slow to the original velocity of stage one, minus losses due to friction etc., and the input shaft again engages the rotating mass such that the energetic drive means is allowed to add rotational energy to compensate for losses. These four stages repeat for as long as the motive force output requirement is maintained. It is the difference in change of direction and initial energy level between stages one and three that produce the unbalanced mass to create a net resultant force vector (442) to provide motive force.

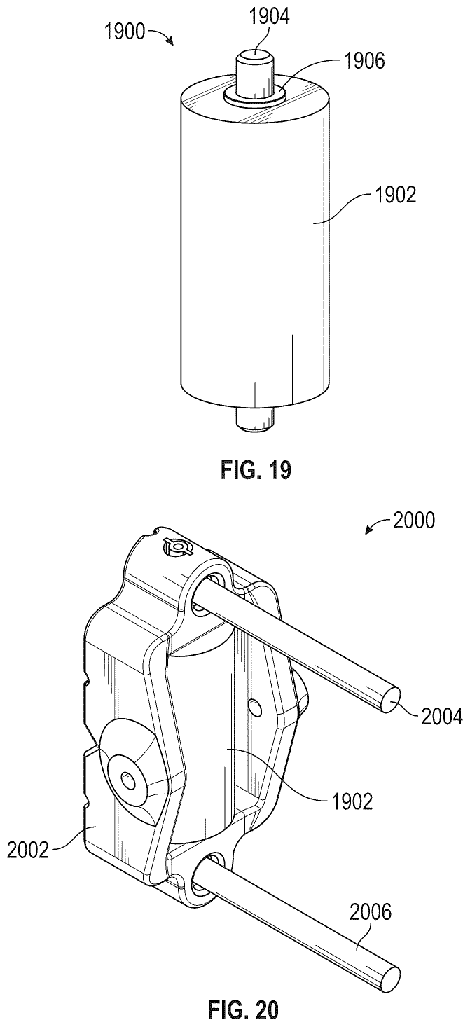

FIG. 19 presents an alternate mass (1900) for utilization with another embodiment of a motive force generation device. In this embodiment the mass has a cylindrical body (1902), axle (1904) establishing an axis of rotation, and bearing faces (1906) for reduction of friction during mass rotation.

The material chosen for the mass should be high density for efficiency of operation. In this embodiment the material chosen is bronze due to availability and machinability. However, other materials may be utilized, for example but not limitation, tungsten, copper, brass, steel, and the like. Moreover, mercury or other dense liquid metal may also be utilized.

FIG. 20 presents the alternate mass carrier assembly (2000). The mass (1902) is supported within the carrier housing (2002) by the protruding axles (1904; not visible) and bearing assembly allowing free rotation of the mass (1902) within the carrier housing (2002). At the bearing end of the carrier housing (2002) are guide holes through which actuator guide rods (2004 and 2006) protrude. The actuator guide rods allow the carrier housing (2002) to slide thereupon, limiting and controlling its movement.

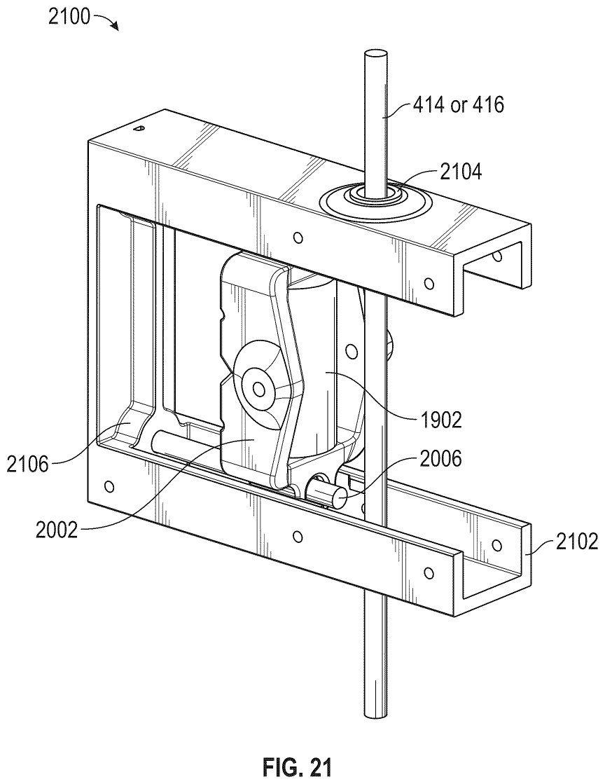

FIG. 21 presents the alternate mass and carrier assembly within the assembly actuator U-shaped mounting bracket (2100). Visible within the mounting bracket (2102) is the lower guide rod (2006). Not visible is the upper guide rod (2004), which is present but obscured by the upper channel arm of the bracket. A mass carrier assembly positioning drive stepper motor actuator (2106) drives the lower guide rod (2006). Threads around the lower guide rod (2006) engage mating threads in the carrier housing (2002) guide hole, allowing the rotation of the stepper motor (2106) to accurately position the carrier housing (2002) and mass assembly anywhere along the length of the guide rod (2006). In this embodiment the upper guide rod (2004) and corresponding carrier housing (2002) guide hole are smooth to reduce friction to facilitate carrier assembly positioning. In another embodiment the upper guide rod (2004) and corresponding carrier housing (2002) guide hole are threaded as are the lower guide rod (2006) and corresponding carrier housing (2002) guide hole, with a stepper motor synchronized with the lower stepper motor actuator (2106), or with a gear arrangement synchronizing rotation of the upper guide rod (2004) with the lower guide rod (2006).

In another embodiment the mass carrier assembly (2002) may slide freely on the upper guide rod (2004) and lower guide rod (2006), with positioning controlled by pneumatic or hydraulic rams. Instead of a stepper motor actuator (2106), a pneumatic (or hydraulic) actuator works upon the carrier housing to control its movement. Positioning may be determined by use of photo-optics, resistance, capacitance, and/or inductance sensors or the like, or some combination thereof.

In this embodiment the lower portion of the mounting bracket (2102) is affixed to a drive gear (402) and respective driven gear (408), such that the axle (414 or 416) pass through the upper bearing (2104) and lower bearing (not visible) as shown, thereby replacing the actuator and mass assembly (406/404 and (410/412) of the previous embodiment. The mounting bracket bearings (2104) allow overrun on a drive gear installation.

As during operation described above, the mass (1902) is moveably positioned along a radius of the gear to which it is mounted, with respect to the axial rotation, to achieve the stated motive force generation. The mass (1902) freely rotates along its axis (1904) with respect to the carrier housing (2002), thereby allowing decoupling of the effects of the mass from the overall system. In another embodiment utilizing liquid mercury or other dense liquid metal as the mass (1902), the fluid action of the liquid flowing within its housing provides the decoupling effect.

The invention may be embodied in other specific forms without departing from the essential characteristics thereof. The described embodiments are therefore to be considered in all respects as illustrative and not restrictive. Accordingly, the scope of the invention is established by the appended claims rather than by the foregoing description.

The recitation of method steps does not denote a limiting sequence for execution of the steps. Such method steps may therefore be performed in a sequence other than that recited unless the claim expressly states otherwise.

I claim:

1. A directional motive force generation device, the device comprising:
a drive gear (402) receiving rotational energy from an energetic drive means (430) to rotate around a first shaft (414, 1114);
a drive mass (404, 1900);
a drive mass actuator (406, 2106) affixed to the drive gear and affixed to the drive mass, the drive mass actuator adapted to moveably position the drive mass along a radius of the drive gear with respect to the drive gear axis of rotation;
a driven gear (408) receiving rotational energy from the drive gear to synchronously counter-rotate around a second shaft (416, 1116);
a driven mass (410, 1900); and
a driven mass actuator (412, 2106) affixed to the driven gear and affixed to the driven mass, the driven mass actuator adapted to moveably position the driven mass along a radius of the driven gear with respect to the driven gear axis of rotation,
wherein the drive gear and the driven gear form a counter-rotating mass pair assembly.

2. The device of claim 1 comprising:
an overrun device (502, 1102) for allowing rotation of the counter-rotating mass pair independent of the energetic drive means when the speed of the mass pair exceeds the drive speed of the energetic drive means.

3. The device of claim 1 comprising:
an actuator sensor (417, 418) for each actuator and a trigger mechanism (440) for synchronously triggering the actuator sensors to signal the actuator to alter the position of the associated mass.

4. The device of claim 3 wherein the trigger mechanism position is alterable to vary the actuator sensor trigger timing.

5. The device of claim 1 comprising:
a braking device (438, 436) for slowing the rotation of the drive and driven gears.

6. The device of claim 1 comprising:
a plurality of counter-rotating mass pair assemblies.

7. The device of claim 1 comprising:
a mass carrier housing (2002) for each of the drive mass actuator (2106) and the driven mass actuator (2106), the mass carrier housing adapted to allow the mass (1900) to rotate about an axis parallel to that of the respective gear to which the respective actuator is affixed.

8. A method for generating a directional motive force, the method steps comprising:
imparting rotational energy on a device comprising at least one pair of counter-rotating masses, each pair comprising a drive mass (404, 1902) rotating about a fixed point defined by a first shaft (414, 1114) and a driven mass (410, 1902) rotating about a fixed point defined by a second shaft (416, 1116) in a direction opposite that of the drive mass and in synchronization with the drive mass;
synchronously altering the radius of rotation of the mass pair to increase the angular velocity of the counter-rotating mass pair during a portion of the rotational period; and
creating a net resultant force for propulsion of the device by synchronously altering the radius of the rotation of the counter-rotating mass pair to decrease the angular velocity of the counter-rotating mass pair during the remaining portion of the rotational period.

9. The method of claim 8, the method steps comprising:
altering the position of a trigger mechanism (440) to vary the rotational period timing during which the angular velocity of the pair of masses increases.

10. The method of claim 8, the method steps comprising:
altering the rotational period timing during which the angular velocity of the pair of masses increases.

11. The method of claim 8, the method steps comprising:
exchanging the period during which the angular velocity of the counter-rotating mass pair increases with the period during which the angular velocity of the counter-rotating mass pair decreases to change the net resultant force.

12. The method of claim 8, the method steps comprising:
decoupling the effects of each mass by allowing each mass to rotate about an axis parallel that of the respective first shaft (414, 114) or second shaft (416, 1116).

13. The method of claim 8, the device comprising:
a plurality of counter-rotating masses.
